(19) United States
(12) Patent Application Publication
(10) Pub. No.: US 2008/0307368 A1
(43) Pub. Date: Dec. 11, 2008

(54) Dynamically adjusting the range of a navigational controller for an infinite workspace

(76) Inventors: Alessandro Sabatelli, San Francisco, CA (US); Nathan Wertman, Boulder Creek, CA (US); Pierre-Olivier Latour, Menlo Park, CA (US)

Correspondence Address: PVF -- APPLE INC.;c/o PARK, VAUGHAN & FLEMING LLP, 2820 FIFTH STREET, DAVIS, CA, 95618-7759, US

(21) Appl. No.: 11/811,115

(22) Filed: Jun. 8, 2007

(51) Int. Cl. G06F 3/048

(52) U.S. Cl. 715/854

(57) ABSTRACT

One embodiment of the present invention provides a system that dynamically adjusts the range of a navigational controller for an infinite workspace within a graphical display environment. During operation, the system determines that an object has moved from an original position to a new position with respect to a display area of the workspace. If the object at the new position is not contained within the display area of the workspace, the system expands the range of the navigational controller so that the object is contained in the display area of the workspace.

### BACKGROUND

1. Field of the Invention

The present invention relates to user-interfaces for computer systems. More specifically, the present invention relates to a method and an apparatus that dynamically adjusts the range of a navigational controller for an infinite workspace.

2. Related Art

Advances in computing technology have led to the development of increasingly more sophisticated graphical user interfaces (GUIs) for computer systems. These GUIs allow users to manipulate large numbers of graphical objects, which can represent applications, such as web browsers, programs, and code editors. Unfortunately, as larger numbers of graphical objects are manipulated, display windows are becoming increasingly more crowded. This is a problem because software developers often have to interact simultaneously with a large number of editor window objects, which involves repeatedly moving back and forth between these editor window objects. Because each object can have a different size and can occupy a significant portion of the display window, it is not always possible to view all of the objects simultaneously inside the display window. It is possible to stack the objects to allow them to be displayed within a single display window simultaneously. However, this may cause links/connections between objects to be blocked from the user, which impedes the user's ability to view and manipulate the objects.

One approach to overcome the problem of crowding within a display window is to create an “infinite workspace,” wherein an arbitrary number of objects can be placed at arbitrary locations and at arbitrary scales. Navigating through such an infinite workspace typically involves grabbing, panning, and zooming through the infinite workspace. However, because the infinite workspace is “unbounded,” it can be difficult to quickly locate and move to objects which are located outside of a presently viewable region of the infinite workspace. Furthermore, when too many objects have been created, a user can easily lose track of objects which are located outside of the viewable region and which have not been recently viewed.

Hence, what is needed is a method and an apparatus that facilitates efficiently navigating through an infinite workspace.

### SUMMARY

One embodiment of the present invention provides a system that dynamically adjusts the range of a navigational controller for an infinite workspace within a graphical display environment. During operation, the system determines that an object has moved from an original position to a new position with respect to a display area of the workspace. If the object at the new position is not contained within the display area of the workspace, the system expands the range of the navigational controller so that the object is contained in the display area of the workspace.

In a variation on this embodiment, if the object is proximate to a boundary of the display area, the system expands the range of the navigational controller so that the object is not proximate to the boundary of the display area.

In a variation on this embodiment, if the object has moved toward the center of the display area and away from a boundary of the display area, and the object is the closest object to the boundary, the system reduces the range of the navigational controller.

In a variation on this embodiment, the movement of the object from the original position to the new position can be caused by: (1) a user dragging the object to the new position; (2) a user changing the size of the object; or (3) a user editing the object.

In a variation on this embodiment, when the system determines that a new object has been created within the graphical display environment, if the new object is not contained in the display area of the workspace, the system expands the range of the navigational controller so that the new object is contained in the display area of the workspace.

In a variation on this embodiment, the range of the navigational controller specifies a bounding box that encloses all objects associated with the workspace.

In a variation on this embodiment, the navigational controller can include: (1) a one-dimensional (1D) navigational controller for a 1D workspace; (2) a two-dimensional (2D) navigational controller for a 2D workspace, which can include two 1D navigational controllers for each dimension or one 2D navigational controller for both dimensions; (3) a multidimensional navigational controller for a multidimensional workspace, which is comprised of multiple 1D navigational controllers for each dimension.

In a further variation on this embodiment, the navigational controller can include a scrollbar.

### BRIEF DESCRIPTION OF THE FIGURES

FIG. 1 illustrates a computer system with a display device in accordance with an embodiment of the present invention.

FIG. 2A illustrates three workspace objects within the display window of the workspace in accordance with an embodiment of the present invention.

FIG. 2B illustrates a user moving an object toward a boundary of the display window in accordance with an embodiment of the present invention.

FIG. 2C illustrates the user continuing to move an object in the same direction in accordance with an embodiment of the present invention.

FIG. 2D illustrates the user further moving the object in the same direction in accordance with an embodiment of the present invention.

FIG. 3A illustrates a workspace object within the display window of the workspace in accordance with an embodiment of the present invention.

FIG. 3B illustrates the user moving the rightmost object in the workspace to the left toward the center of the display window in accordance with an embodiment of the present invention.

FIG. 3C illustrates the user continuing to move the rightmost object to the left in accordance with an embodiment of the present invention.

FIG. 4 presents a flowchart illustrating the process of dynamically expanding the extent of a workspace in accordance with an embodiment of the present invention.

FIG. 5 presents a flowchart illustrating the process of dynamically reducing the extent of a workspace in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the claims.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs), DVDs (digital versatile discs or digital video discs), or any device capable of storing data usable by a computer system.

### Computer System

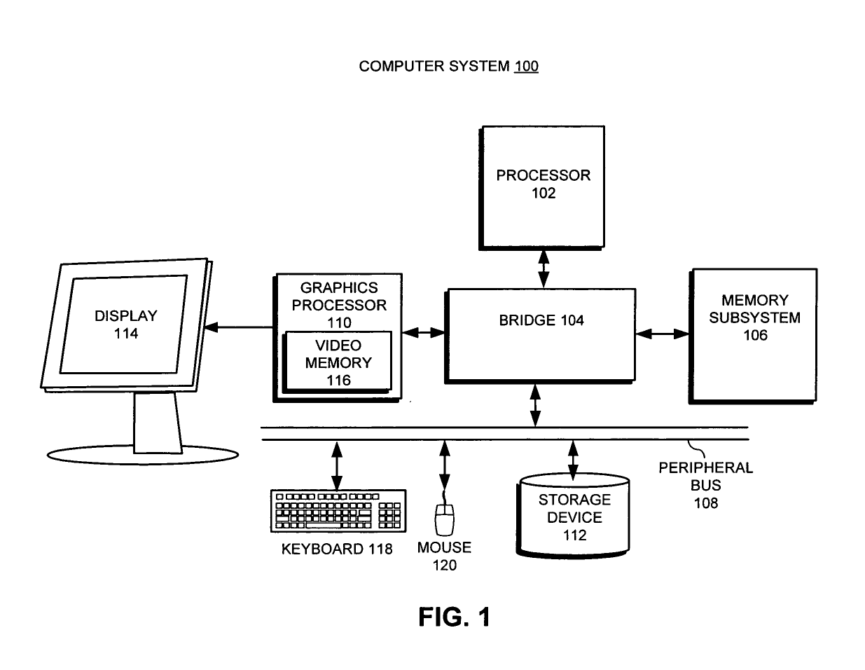

FIG. 1 illustrates a computer system 100 with a display device in accordance with an embodiment of the present invention. As illustrated in FIG. 1, computer system 100 includes processor 102, which is coupled to a memory subsystem 106, a peripheral bus 108, and a graphics processor 110 through bridge 104. Bridge 104 can include any type of core logic unit, bridge chip, or chipsets that are commonly used to couple together components within computing system 100. Processor 102 can include any type of processor, including, but not limited to, a microprocessor, a digital signal processor, a device controller, or a computational engine within an appliance.

It should be recognized that one or more components of the computer system 100 may be located remotely and accessed via a network.

Processor 102 communicates with memory subsystem 106 through bridge 104. Memory subsystem 106 can include a number of components, including one or more memory chips which can be accessed by processor 102 at high speed.

Processor 102 also communicates with storage device 112 through bridge 104 and peripheral bus 108. Storage device 112 can include any type of non-volatile storage device that can be coupled to a computer system. This includes, but is not limited to, magnetic, optical, and magneto-optical storage devices, as well as storage devices based on flash memory and/or battery-backed up memory.

Processor 102 additionally communicates with graphics processor 110 through bridge 104. Graphics processor 110 is a specialized graphics rendering device that provides a signal source to display 114 and drives display 114. Display 114 can include any type of display device that can present information in a visual format (including images and text) to a user. This includes, but is not limited to, cathode ray tube (CRT) displays, light-emitting diode (LED) displays, liquid-crystal displays (LCD), organic LED (OLED) displays, surface-conduction electron-emitter displays (SED), or electronic paper.

Graphics processor 110 performs both 2D and 3D graphics-rendering operations, such as lighting, shading, transforming, with high performance. To achieve the high performance, graphics processor 110 may use dedicated video memory 116 to store frame buffers, textures, vertex arrays, and/or display lists.

Both display 114 and graphics processor 110 typically operate through a window manager, which manages interactions between a user and user applications. In doing so, the window manager accepts user inputs through input devices, for example, through a keyboard 118 or a mouse 120, and translates them into corresponding actions directed to the user applications. The window manager can then cause the corresponding actions to be performed, possibly based on predefined policies. A window manager can also accept requests from the user applications.

Note that although the present invention is described in the context of computer system 100 illustrated in FIG. 1, the present invention can generally operate on any type of computing device that supports a graphical user interface. Hence, the present invention is not limited to the computer system 100 illustrated in FIG. 1.

### Dynamically Adjusting Extent of Workspace

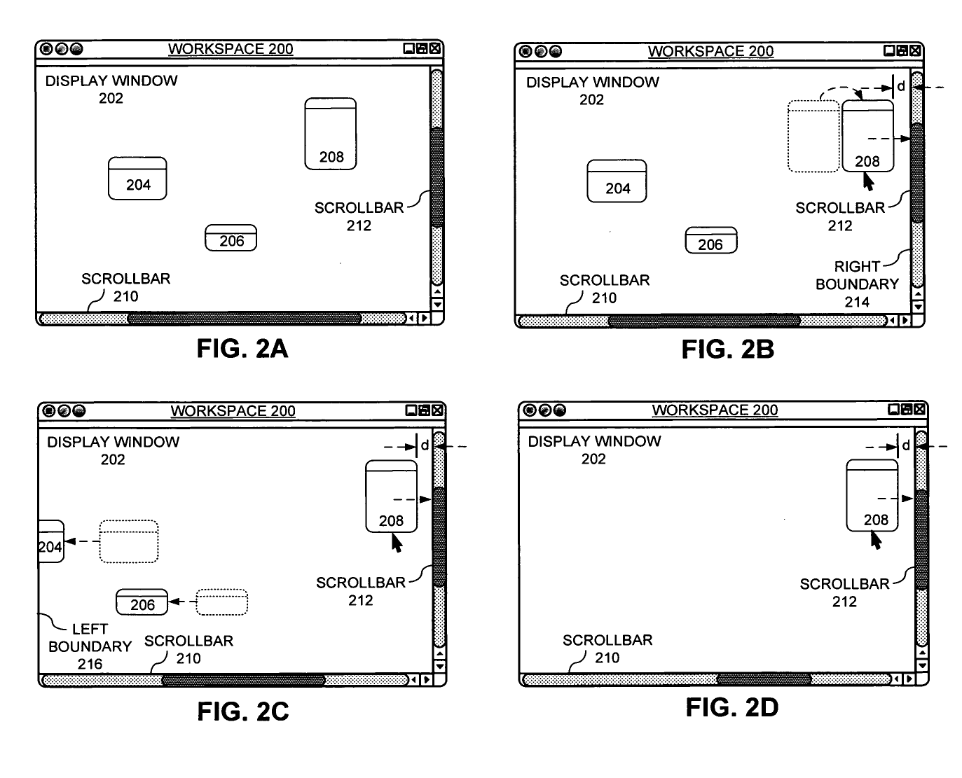

FIGS. 2A-2D illustrate an exemplary user interface for an infinite workspace 200 and a sequence of operations associated with expanding the extent of the workspace in accordance with an embodiment of the present invention.

FIG. 2A illustrates three workspace objects 204-208 within a display window 202 of workspace 200 in accordance with an embodiment of the present invention. Note that objects 204-208 can include any type of user application or object, such as a code module, a web browser, a personal information manager (PIM), or an integrated development environment (IDE).

In one embodiment of the present invention, display window 202 displays the viewable region of workspace 200. Hence, workspace objects that are outside display window 202 are not visible. Note that display window 202 includes two one-dimensional (ID) scrollbars: (1) a horizontal scrollbar 210, and (2) a vertical scrollbar 212, wherein the scrolling range of a scrollbar defines the present extent of workspace 200 in the associated direction. Hence, sliding a slider of a scrollbar allows hidden portions of workspace 200 to be displayed in the visible region. For example, in FIG. 2A, the sliders in scrollbar 210 and scrollbar 212 can each slide a certain distance in their corresponding directions, which implies that the extent of workspace 200 in both directions is greater than the associated dimensions of display window 202. In this embodiment, object 204 represents the leftmost object in display window 202 while object 208 represents the rightmost object in display window 202.

In one embodiment of the present invention, the full range of scrollbars 210 and 212 corresponds to a bounding box that encompasses all the objects associated with workspace 200.

FIG. 2B illustrates a user moving object 208 toward a boundary of display window 202 in accordance with an embodiment of the present invention.

In one embodiment, to move object 208 from the initial position in FIG. 2A to the new position in FIG. 2B, the user selects object 208 using a cursor and drags object 208 to the right. While object 208 is being moved toward right boundary 214, the system continuously monitors the position of object 208. If object 208 remains inside display window 202, the system allows object 208 to continuously move in that direction. Note that in response to object 208 moving to the right, the slider in horizontal scrollbar 210 retracts on the right side, which effectively causes the scrolling range to expand to the right. Because the scrolling range defines the extent of the workspace, the extent of workspace 200 is also expanded to the right.

In one embodiment of the present invention, if object 208 is sufficiently close to boundary 214 of display window 202, the system does not allow object 208 to move further to the right with respect to the boundary of the viewable region. Instead, as object 208 moves, the system maintains object 208 at a predetermined distance d from right boundary 214. This prevents object 208 from being partially or completely moved outside display window 202, and facilitates keeping object 208 fully contained in the viewable region.

FIG. 2C illustrates the user continuing to move object 208 to the right of the display window in accordance with an embodiment of the present invention.

After object 208 has reached the closest allowed distance d to boundary 214, user action to further move object 208 to the right causes the extent of workspace 200 to continuously grow in the horizontal direction. Because object 208 remains a predetermined distance from the right boundary of the viewable region, expanding workspace 200 causes other objects in workspace 200 to move away from object 208. More specifically, objects 204 and 206 move to the left toward left boundary 216 in response to dragging object 208 further to the right. Simultaneously, the system expands the scrolling range of scrollbar 210 which, in turn, expands the extent of workspace 200. This is illustrated in FIG. 2C wherein the slider of scrollbar 210 retracts on the left side which effectively allows it to slide further to the left within scrollbar 210.

FIG. 2D illustrates the user further moving object 208 to the right of the display window in accordance with an embodiment of the present invention. As seen in FIG. 2D, object 208 remains at the same position in display window 202, while both objects 204 and 206 have completely moved outside display window 202. Meanwhile, the scrolling range of scrollbar 210 continues to expand toward the left. Hence, both objects 204 and 206 remain inside the bounding box for workspace 200 and can be brought back to the viewable region by sliding the slider of scrollbar 210 to the left. In one embodiment of the present invention, the expansion of workspace 200 can be unbounded, to effectively create an “infinite workspace.” However, the actual extent of workspace 200 is defined by the scrolling ranges of the scrollbars.

Note that the range of the vertical scrollbar 212 does not change in response to the user action because there is no vertical movement. Hence workspace 200 is not expanded in the vertical direction. Also note that in the embodiments associated with FIGS. 2C-2D, the object that the user is actively interacting with (object 208) remains fully visible to the user.

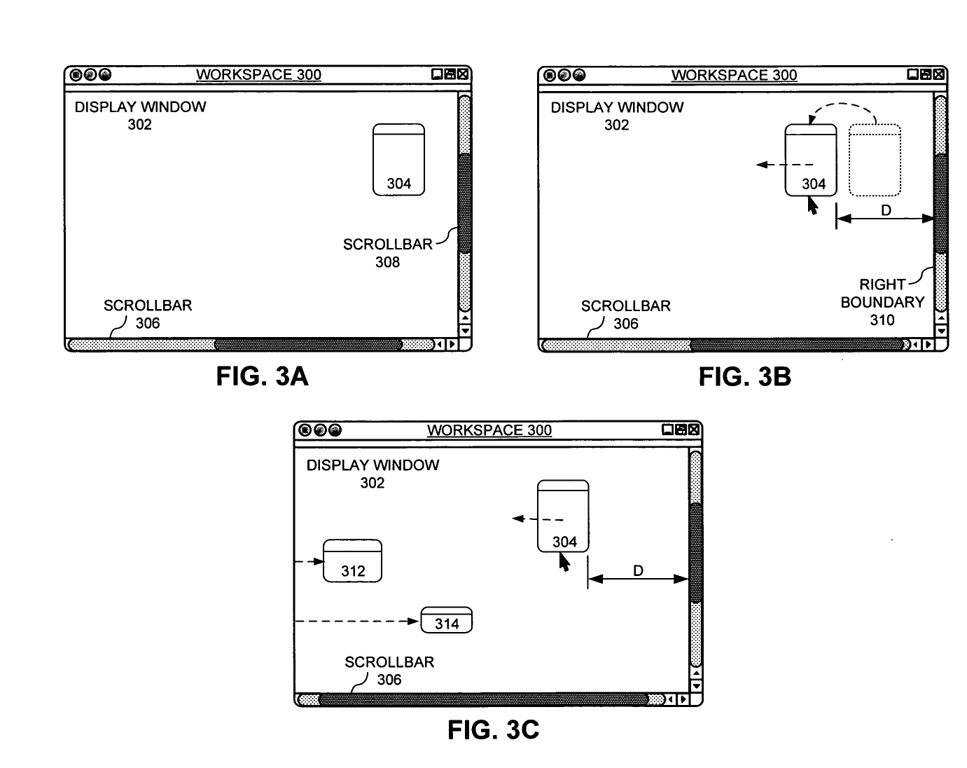

FIGS. 3A-3C illustrate an exemplary user interface for a workspace 300 and a sequence of events associated with reducing the extent of the workspace in accordance with an embodiment of the present invention.

More specifically, FIG. 3A illustrates a workspace object 304 within a display window 302 of workspace 300 wherein object 304 can include any type of user application or object, such as a code module, a web browser, a personal information manager (PIM), or an integrated development environment (IDE).

In one embodiment of the present invention, display window 302 displays the viewable region of workspace 302. Note that display window 302 includes two ID scrollbars 306 and 308, wherein the scrolling range of a specific scrollbar defines the present extent of workspace 300 in the associated direction for the scrollbar. In this embodiment, object 304 is both the rightmost object in display window 302 and the rightmost object in workspace 300.

FIG. 3B illustrates the user moving the rightmost object 304 in workspace 300 to the left toward the center of display window 302 in accordance with an embodiment of the present invention. In one embodiment, to move object 304 from the initial position in FIG. 3A to the new position in FIG. 3B, user selects object 304 using a cursor and drags object 304 to the left. While object 304 is being moved, the system continuously monitors the position of object 304. Note that in response to object 304 moving to the left, the slider of horizontal scrollbar 306 grows longer on the right side, which effectively causes the scrolling range to reduce in size in that direction. This, in turn, reduces the extent of workspace 300. In one embodiment, the system determines that object 304 has reached a predetermined largest distance D from right boundary 310 and that object 304 is the rightmost object in workspace 300. In this case, the system does not allow object 304 to move further to the left. Instead, as object 304 continues to move to the left, the system maintains object 304 at the distance D from right boundary 310, and the system begins to reduce the extent of workspace 300 by moving objects to the left of object 304 toward object 304. In doing so, the system prevents the creation of a large empty space between the rightmost object 304 and right boundary 310 of display window 302.

FIG. 3C illustrates the user continuing to move the rightmost object 304 to the left in accordance with an embodiment of the present invention. While further dragging object 304 to the left, object 304 remains at a distance D from the right boundary. However, objects 312 and 314 which were outside display window 302 in FIGS. 3A and 3B now move into display window 302 toward object 304. In particular, the distance that objects 312 and 314 move to the right is equivalent to the intended travel distance of object 304 to the left. Simultaneously, the system reduces the scrolling range of scrollbar 306. As seen in FIG. 3C, the slider of scrollbar 306 grows longer on the left side, which effectively reduces the extent of workspace 300 from the left. However, the full range of scrollbar 306 continues to be defined by a bounding box that encompasses all the objects associated with workspace 300.

Note that although the above descriptions associated with FIGS. 2A-2D and FIGS. 3A-3C illustrate the process of moving objects in the horizontal direction, the general techniques are not limited to a particular direction. Hence, the above-described techniques can be used when an object is dragged in an arbitrary direction in a two-dimensional (2D) display window, for example, along the diagonal of the display window. Specifically, embodiments of the present invention allow the ranges of both horizontal and vertical scrollbars to vary at the same time. Consequently, the extent of workspace can simultaneously expand or reduce in both horizontal and vertical directions.

Note that as an alternative to using two 1D scrollbars (X and Y) to define the extent of a workspace, a single 2D scrollbar, or any other type of 2D navigational controller can be used to perform the functions of two 1D scrollbars. For example, such a 2D navigational controller can be a rectangular button inside a small overview pane representing the entire workspace, wherein the rectangular button can be moved around in any direction within the overview pane, and the size of the rectangular button can change to reflect the change of the extent of the 2D workspace.

Furthermore, the present invention can also be extended to a three-dimensional (3D) display window of a 3D workspace, wherein navigating through the 3D workspace can be performed by using either three separate 1D navigational controllers for each dimension (i.e., X, Y, and Z) or by using a single 3D navigational controller for all three dimensions. Note that the present invention can also be applied to a multidimensional display environment which has more than three dimensions. In this case, navigating through an n-dimensional (nD) space can be performed by using n (n>3) separate 1D navigational controllers for each dimension.

Other Events that Can Change the Extent of a Workspace

Resizing an Object in the Workspace

In addition to moving an object from one location to another in a workspace, a user often resizes an object. For example, a user can enlarge an application window to occupy more display space, or conversely, can reduce the size of the application window to occupy a smaller portion of the display window. Typically, when the user enlarges the object, the maximum allowable object size is limited by the display window boundaries. Embodiments of the present invention allow a user to continuously enlarge an object beyond a display window boundary by increasing the extent of the associated workspace. This can be achieved by expanding the range of the navigational controller that defines the extent of the workspace.

Editing an Object in the Workspace

When a user edits an object, the size of the object can change accordingly. For example, when the user adds content to an object, the size of the object can grow. Conversely, when the user removes content from an object, the object can reduce in size. Embodiments of the present invention can dynamically adjust the size of the workspace in response to the growing/shrinking of objects. This is achieved by expanding/reducing the range of the navigational controller, so that all of the objects in the workspace remain within the range of the navigational controller.

Creating a New Object in the Workspace

In one embodiment of the present invention, if a new object is created, the system determines the position of the new object in relation to the workspace. If the position is outside the extent of the workspace that is defined by the range of the navigational controller, the system expands the range so that the new object is contained within the expanded workspace.

### Process of Dynamically Adjusting Extent of a Workspace

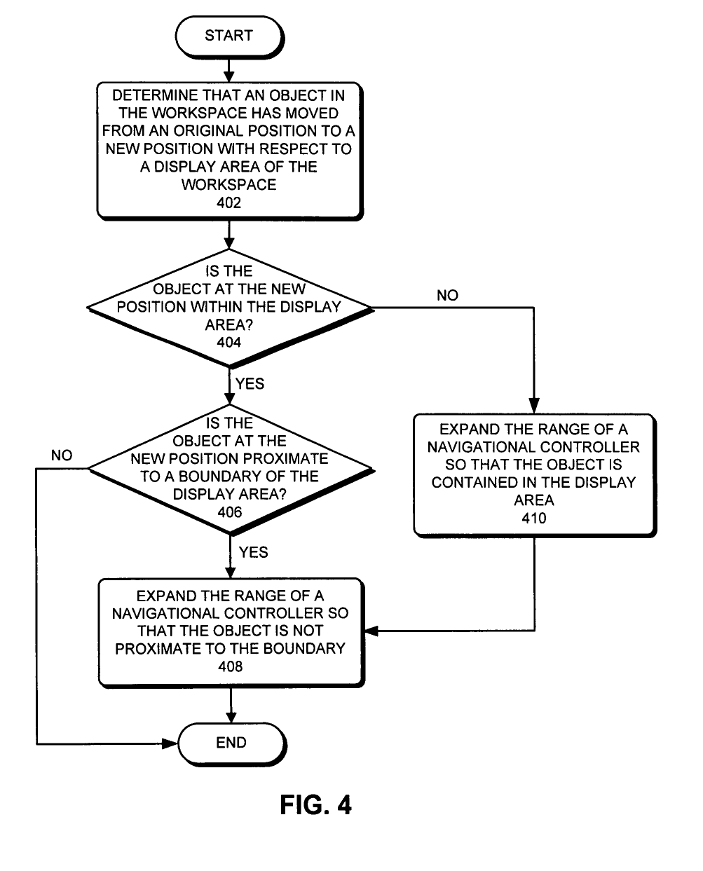

FIG. 4 presents a flowchart illustrating the process of dynamically expanding the extent of a workspace in accordance with an embodiment of the present invention. During this process, the system determines that an object in the workspace has moved from an original position to a new position with respect to a display area of the workspace (step 402). The system then determines if the object at the new position is within the display area of the workspace (step 404). If so, the system further determines if the object at the new position is proximate to a boundary of the display area (step 406). If so, the system expands the range of a navigational controller so that the object is not proximate to the boundary of the display area (step 408). In doing so, the system expands the extent of the workspace.

If the object at the new position is not inside the display area, the system expands the range of the navigational controller so that the object is contained in the display area of the workspace (step 410). In doing so, the system also expands the extent of the workspace.

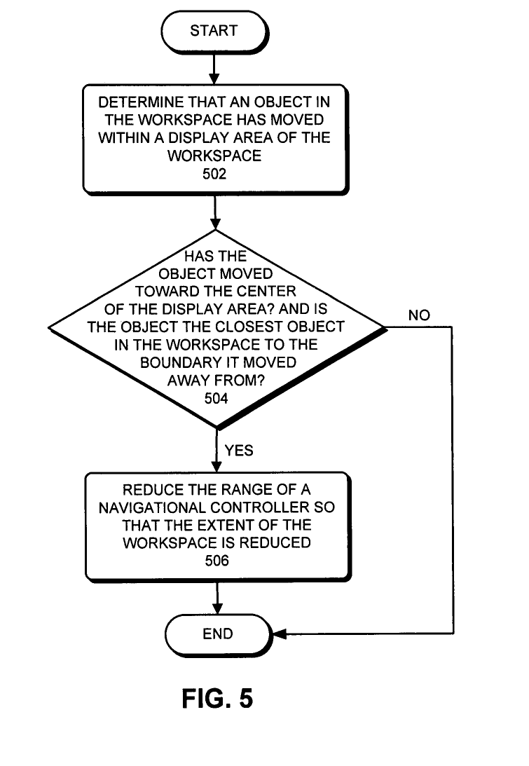

FIG. 5 presents a flowchart illustrating the process of dynamically reducing the extent of a workspace in accordance with an embodiment of the present invention.

During operation, the system determines that an object in the workspace has moved within a display area of the workspace (step 502). The system then determines if the object has moved toward the center of the display area and away from a boundary of the display area, and if the object is the closest object in the workspace to that boundary (step 504). If so, the system reduces the range of the navigational controller so that the extent of the workspace is reduced (step 506).

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for dynamically adjusting the range of a navigational controller for a workspace which is infinite, the method comprising:
determining that an object has moved from an original position to a new position with respect to a display area of the workspace; and
if the object at the new position is not contained within the display area of the workspace, expanding the range of the navigational controller so that the object is contained in the display area of the workspace.

2. The method of claim 1, wherein if the object is proximate to a boundary of the display area, the method further comprises expanding the range of the navigational controller so that the object is not proximate to the boundary of the display area.

3. The method of claim 1, wherein if the object has moved toward the center of the display area and away from a boundary of the display area, and the object is the closest object to the boundary, the method further comprises reducing the range of the navigational controller.

4. The method of claim 1, wherein the movement of the object from the original position to the new position involves:
a user dragging the object to the new position;
a user changing the size of the object; or
a user editing the object.

5. The method of claim 1, wherein the method further comprises:
determining that a new object has been created within a graphical display environment associated with the workspace; and
if the new object is not contained in the display area of the workspace, expanding the range of the navigational controller so that the new object is contained in the display area of the workspace.

6. The method of claim 1, wherein the range of the navigational controller specifies a bounding box that encloses all objects associated with the workspace.

7. The method of claim 1, wherein the navigational controller can include:
a one-dimensional (1D) navigational controller for a 1D workspace;
a two-dimensional (2D) navigational controller for a 2D workspace, which can include:
two 1D navigational controllers for each dimension; or
one 2D navigational controller for both dimensions; or
a multidimensional navigational controller for a multidimensional workspace, which is comprised of multiple 1D navigational controllers for each dimension.

8. The method of claim 7, wherein the navigational controller can include a scrollbar.

9. A computer-readable storage medium storing instructions that when executed by a computer cause the computer to perform a method for dynamically adjusting the range of a navigational controller for a workspace which is infinite, the method comprising:
determining that an object has moved from an original position to a new position with respect to a display area of the workspace; and
if the object at the new position is not contained within the display area of the workspace, expanding the range of the navigational controller so that the object is contained in the display area of the workspace.

10. The computer-readable storage medium of claim 9, wherein if the object is proximate to a boundary of the display area, the method further comprises expanding the range of the navigational controller so that the object is not proximate to the boundary of the display area.

11. The computer-readable storage medium of claim 9, wherein if the object has moved toward the center of the display area and away from a boundary of the display area, and the object is the closest object to the boundary, the method further comprises reducing the range of the navigational controller.

12. The computer-readable storage medium of claim 9, wherein the movement of the object from the original position to the new position involves:
a user dragging the object to the new position;
a user changing the size of the object; or
a user editing the object.

13. The computer-readable storage medium of claim 9, wherein the method further comprises:
determining that an new object has been created within a graphical display environment associated with the workspace; and
if the new object is not contained in the display area of the workspace, expanding the range of the navigational controller so that the new object is contained in the display area of the workspace.

14. The computer-readable storage medium of claim 9, wherein the range of the navigational controller specifies a bounding box that encloses all objects associated with the workspace.

15. The computer-readable storage medium of claim 9, wherein the navigational controller can include:
a one-dimensional (1D) navigational controller for a 1D workspace;
a two-dimensional (2D) navigational controller for a 2D workspace, which can include:
two 1D navigational controllers for each dimension; or
one 2D navigational controller for both dimensions; or
a multidimensional navigational controller for a multidimensional workspace, which is comprised of multiple 1D navigational controllers for each dimension.

16. The computer-readable storage medium of claim 15, wherein the navigational controller can include a scrollbar.

17. An apparatus that dynamically adjusts the range of a navigational controller for a workspace which is infinite, comprising:
a determination mechanism configured to determine that an object has moved from an original position to a new position with respect to a display area of the workspace; and
an expansion mechanism configured to expand the range of the navigational controller so that the object at the new position is contained in the display area of the workspace.

18. The apparatus of claim 17, wherein if the object is proximate to a boundary of the display area, the expansion mechanism is further configured to expand the range of the navigational controller so that the object is not proximate to the boundary of the display area.

19. The apparatus of claim 17, wherein if the object has moved toward the center of the display area and away from a boundary of the display area, and the object is the closest object to the boundary, the method further comprises a reducing mechanism configured to reduce the range of the navigational controller.

20. The apparatus of claim 17, wherein the movement of the object from the original position to the new position involves:
a user dragging the object to the new position;
a user changing the size of the object; or
a user editing the object.

21. The apparatus of claim 17,
wherein the determination mechanism is further configured to determine that an new object has been created within a graphical display environment associated with the workspace; and
wherein if the new object is not contained in the display area of the workspace, the expansion mechanism is further configured to expand the range of the navigational controller so that the new object is contained in the display area of the workspace.

22. The apparatus of claim 17, wherein the range of the navigational controller specifies a bounding box that encloses all objects associated with the workspace.

23. The apparatus of claim 17, wherein the navigational controller can include:
a one-dimensional (1D) navigational controller for a 1D workspace;
a two-dimensional (2D) navigational controller for a 2D workspace, which can include:
two 1D navigational controllers for each dimension; or
one 2D navigational controller for both dimensions; or
a multidimensional navigational controller for a multidimensional workspace, which is comprised of multiple 1D navigational controllers for each dimension.

24. The apparatus of claim 23, wherein the navigational controller can include a scrollbar.
